(19) United States
(12) Patent Application Publication
(10) Pub. No.: US 2008/0223814 A1
(43) Pub. Date: Sep. 18, 2008

(54) BOTTLE-OPENER FOR UNCAPPING A BOTTLE NECK

(75) Inventors: Jacques BARANGE, Champillon (FR); Christian GONZALEZ, Hautvillers (FR); Jerome COLLARD, Epernay (FR)

Correspondence Address: DENNISON, SCHULTZ & MACDONALD, 1727 KING STREET, SUITE 105, ALEXANDRIA, VA, 22314, US

(73) Assignee: ALCAN PACKAGING CAPSULES, Courbevoie (FR)

(21) Appl. No.: 11/949,941

(22) Filed: Dec. 4, 2007

(30) Foreign Application Priority Data
Mar. 13, 2007 (FR) 07 53785

(51) Int. Cl. B67B 7/16; B65D 51/24

(52) U.S. Cl. 215/304; 81/3.42

(57) ABSTRACT

A bottle-opener for a closure for a bottle neck includes a hood 30 equipped with a first hook 38 comprising a contact surface with a lower surface of the closure, and a transmission lever hinged 32 on the hood and provided with a grip section 52 and a working portion 54 suitable for coming to bear against an upper surface of the closure.

### BACKGROUND OF THE INVENTION

The present invention relates to the field of capping bottles containing beverages and opening them by uncapping.

More specifically, the present invention concerns a bottle-opener uncapping a bottle neck.

To close a bottle, a metal closure is conventionally used, provided with a leak-tight seal forming a barrier between the liquid inside the bottle and the surrounding environment.

To open a bottle fitted with such a closure, a bottle-opener is generally used which comprises a handle and a head provided with an opening so as to rest against a lower surface and an upper surface of the closure.

Such bottle-openers are effective for uncapping operations. However, if it is desired to integrate an uncapping system into the bottle, they turn out to be inappropriate.

The present invention therefore aims at providing a remedy to this drawback.

### SUMMARY OF THE INVENTION

The purpose of the present invention is also to make provision for a bottle-opener for a bottle closure which is particularly practical, effective, simple and economical.

According to an initial aspect, the subject of the invention is a bottle-opener for the closure of a bottle neck, comprising a hood equipped with a first hook comprising a contact surface with a lower surface of the closure, and a transmission lever hinged on the hood and provided with a gripping portion and a working portion suitable for coming to bear against an upper surface of the closure.

With such a bottle-opener, it is possible to open a closure fitted to a bottle neck in a particularly simple and effective way.

When the transmission lever connected to the hood has come to bear against the upper surface of the closure and the user continues to turn the transmission lever, the first hook tends to move upwards, which causes the closure to be removed.

In addition, providing a hood including a hook makes it possible to mount the bottle-opener on the bottle, once the closure has been fitted and before the bottle is put on sale. The hook provides a means of holding the bottle-opener axially onto the closure. This gives a bottle with an integrated closure removal system.

The first hook is, to advantage, aligned radially with the transmission lever; it is not offset circumferentially.

In one embodiment of the invention, the hood additionally includes two other hooks, circumferentially offset on either side of the position diametrically opposite the first hook.

The hood preferably includes a ring-shaped skirt. The hook(s) is/are located on an axial end of the skirt. They (it) extend(s) radially towards the inside.

In one embodiment of the invention, the hood includes a radial portion equipped with at least one elastic component located on the radial portion and suitable for coming to bear against the upper surface of the closure. The elastic component makes it possible to increase the stability of the bottle-opener when it is assembled on the closure by substantially limiting the risk of damaging the latter, when it has a slightly convex overall shape.

The transmission lever can advantageously include a recess to fit the finish of the bottle neck.

In one embodiment of the invention, the bottle-opener also includes an overcap as part of the package design of the bottle.

In one embodiment of the invention, the bottle-opener is produced using at least one synthetic material, for example by molding. Other materials can obviously also be used, for example metal or wood.

According to a second aspect, the invention also concerns a closure assembly comprising a closure to be fitted to a bottle neck, and a bottle-opener provided with a hood comprising at least one means of holding said hood axially onto the closure and a transmission lever hinged on the hood and provided with a gripping portion and a working portion suitable for coming to bear against an upper surface of the closure.

Lastly, the invention also relates to a bottle containing a beverage, in particular an effervescent liquid, provided with a closure assembly such as defined above.

### BRIEF DESCRIPTION OF THE DRAWINGS

A better understanding of the present invention will be obtained by studying embodiments taken as examples that are in no way restrictive, and illustrated by the drawings to be found in the appendix, in which:

FIGS. 1 and 2 are cross-sections of a bottle-opener according to a first embodiment of the invention assembled on the neck of a bottle,

FIGS. 3 and 4 are three-dimensional views of the bottle-opener shown in FIGS. 1 and 2, and

FIG. 5 is a cross-section of a bottle-opener according to a second embodiment of the invention.

### DESCRIPTION OF THE PREFERRED EMBODIMENTS

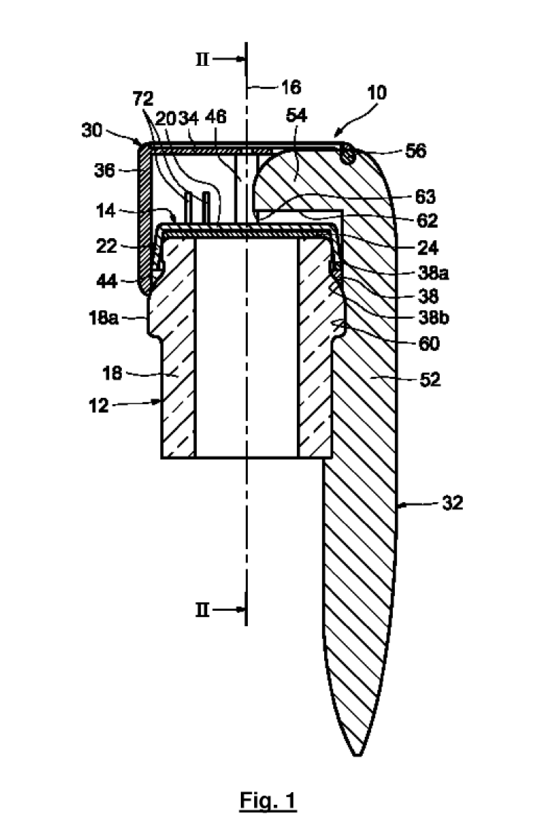

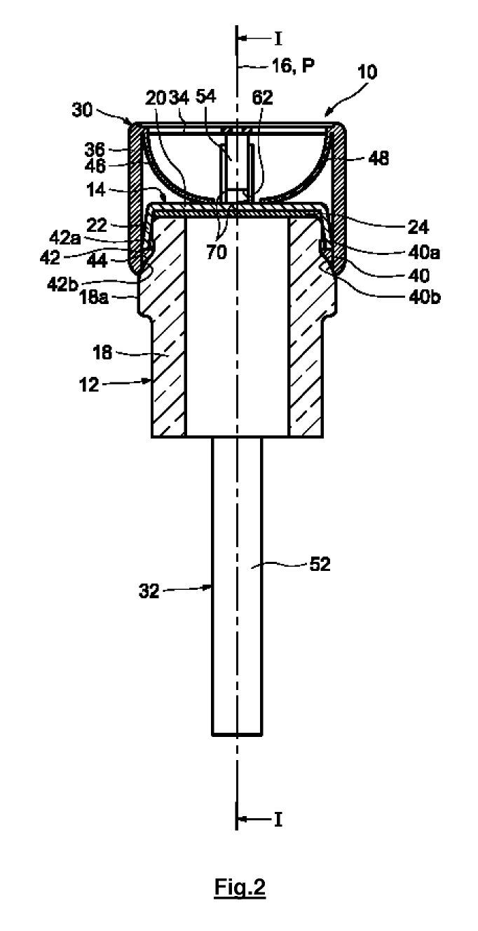

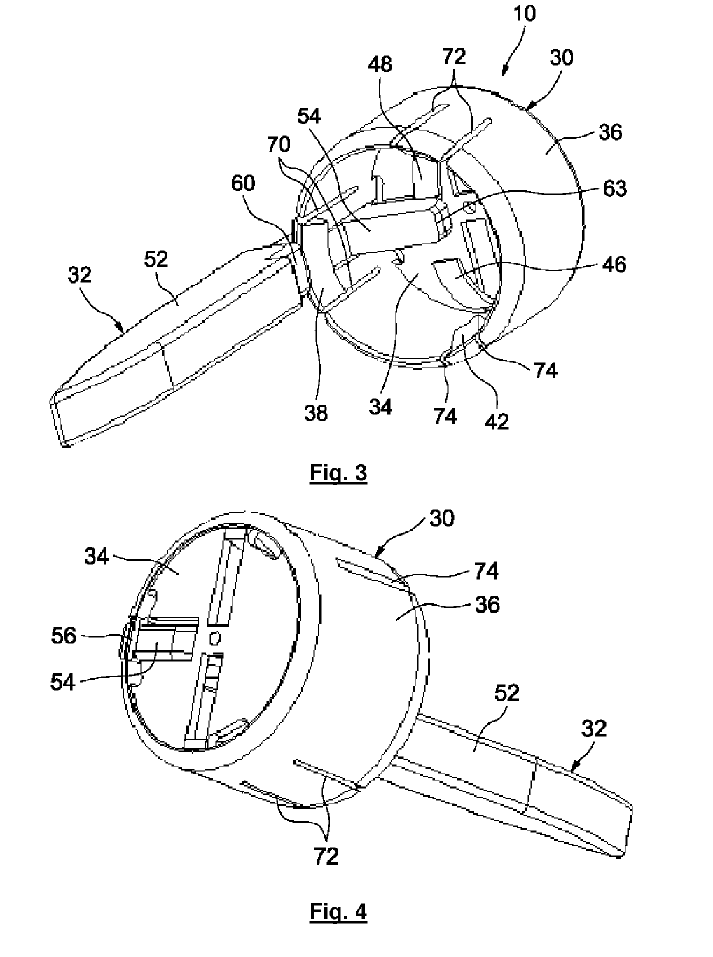

FIGS. 1 to 4 show a bottle-opener 10 intended for opening a bottle 12 on which is fitted a closure 14. In FIGS. 1 and 2, the bottle-opener 10 is shown in a position assumed to be vertical.

Bottle 12, with axis 16, is shown partially here. It includes a collar 18, the top end of which is covered by the closure 14.

The closure 14 includes a radial portion 20 that closes the top end of the neck 18, and an axial portion 22 designed to be compressed around the circumference of the neck. The radial portion 22 is generally produced as a number of teeth. The closure 14 also includes a seal 24 molded or inserted into the radial portion 20 and the axial portion 22. The seal 24 bears against the top end of neck 18. It can, for example, be made out of polyethylene (PE). The seal 24 is here substantially flat. As a variant, it can also include a short axial skirt protruding inside the neck 18 of the bottle 12.

The bottle-opener 10, coaxial with axis 16, primarily comprises a cover or hood 30 and a transmission lever 32, hinged on hood 30 to allow bottle 12 to be uncapped or opened.

Hood 30 comprises a radial portion 34 centered on axis 16 and a ring-shaped skirt 36 extending axially downwards from an edge with a large diameter of the radial portion 34. Radial portion 34 is offset axially upwards in relation to the closure 14, so that there exists an axial space between the radial portion 34 of hood 30 and the radial portion 20 of closure 14.

Hood 30 also includes hooks 38, 40 and 42 located on the free lower end of skirt 36 and extending radially towards the inside. Hooks 38, 40 and 42 are arranged on the same radial plane.

More specifically, hooks 38, 40 and 42 each comprise a radial surface 38a, 40a, 42a extending radially towards the inside of an internal edge of skirt 36, which is extended at the level of a small-diameter edge by a tapered surface 38b, 40b, 42b widening towards the outside and connected to an outer edge of skirt 36. Radial surfaces 38a, 40a, 42a form contact surfaces with a lower surface of the axial portion 22 of closure 14. The radial dimension of surfaces 38a, 40a, 42a is greater than that of the axial portion 22 of closure 14. The tapered surfaces 38b, 40b, 42b form bearing surfaces on a ring-shaped upper surface 44 of the finish 18a of the neck 18 of bottle 12.

Ends of hooks 38, 40 and 42 of hood 30 are located on a circle of a smaller diameter than that of the axial portion 22 of closure 14, so that there exists diametric or radial interference between these two parts. Hooks 38, 40 and 42 thereby form means of holding hood 30 axially, and more generally of holding bottle-opener 10 on closure 14 and bottle 12.

As will be described in greater detail below, when using bottle-opener 10, hook 38 makes it possible to obtain removal of closure 14.

Hood 30 also includes slits 70, 72 and 74 worked into the thickness of skirt 36. Slits 70, of which there are two, extend axially from the lower free end of skirt 36 over practically the entire height of the latter.

Each slit 70 is located angularly in the immediate vicinity of one of the circumferential free ends of hook 38. In other words, slits 70 delimit, on skirt 36, a tab which includes hook 38 on its free end.

Similarly, slits 72 and 74 are associated with hooks 40 and 42 respectively. However, slits 72 and 74 have a smaller axial dimension than slits 70. Slits 72 and 74 extend here from the lower free end of skirt 36 halfway down the latter.

Hood 30 also includes elastic plates or brackets 46, 48 which are generally curved in shape. Brackets 46, 48 extend from a lower surface of the radial portion 34 of hood 30, until they come to bear against the upper surface of the radial portion 20 of closure 14. The root of brackets 46, 48 is located in the vicinity of skirt 36. Legs 46 and 48 are symmetrical with each other in relation to an axial median plane P containing axis 16.

In order for the transmission lever 32 to be hinged on hood 30, the latter also includes an axis 56 worked into skirt 36, axially in the vicinity of the radial portion 34. Axis 56 extends perpendicularly to the plane of FIG. 1. Skirt 36 is discontinuous at one point of its circumference and bounded circumferentially by two axial surfaces (no reference numbers) extending over the full height of said skirt. Axis 56 extends transversely between these two axial surfaces.

Axis 56 and hook 38 are contained within the median plane P containing axis 16, as will be described in greater detail below. Hook 38 and transmission lever 32 are therefore aligned radially.

Transmission lever 32 comprises an axial grip section 52 and a working portion 54, extending a top end of the gripping portion radially towards the inside. Its general shape is that of an L.

The grip section 52 of the transmission lever 32 appears as a rod which extends axially downwards, along bottle 12. Here ‘rod’ is taken to mean any part of a generally long and slender shape, whatever its cross section, which can be indifferently rectangular, round, parallelepipedic, oval, etc.

The transmission lever 32 comprises a recess 60 matching the shape of the finish 18a of the neck 18 of the bottle. Recess 60 makes it possible to position the grip section 52 against bottle 12.

The grip section 52 comprises, at its top end, a C-shaped recess (no reference number) corresponding to the diameter of axis 56 so that the transmission lever 32 can be clipped onto said axis 56. It is obviously possible for the transmission lever 32 to be fitted onto hood 30 by any other suitable means.

The working portion 54 of the transmission lever 32 has an overall rectangular shape and extends radially towards the inside of skirt 36, through the space engineered between the two axial surfaces circumferentially bounding said skirt. Working portion 54 comprises a lower radial surface 62 whose free end or point 63 is designed to bear against the upper surface of the radial portion 20 of closure 14. Working portion 54 is designed so that point 63 is substantially located at the level of axis 16.

The transmission lever 32 can to advantage be made in a single piece by molding a synthetic material, such as polyoxymethylene (POM) or polycarbonate (PC). In a similar way, hood 30 is also obtained by molding a synthetic material, for example POM or PC, so as to obtain a single-piece part. Transmission lever 32 and hood 30 can be made from the same material or from different materials, for example from metal or vegetable materials.

To remove the closure 14, one proceeds as follows:

In the first stage, the bottle-opener 10 is fitted to the neck of bottle 12 so that hooks 38, 40 and 42 clip under closure 14, i.e. so that the radial contact surfaces 38a, 40a and 42a come to bear against the lower surface of the axial portion 22 of closure 14. In this position, the tapered surfaces 38b, 40b and 42b rest against the upper surface 44 of the finish 18a of bottle 12. Bottle-opener 10 is made easier to fit by the presence of slits 70 to 74.

Next, transmission lever 32 is pivoted around axis 56, via grip section 52, so that the working portion 54, and more specifically, point 63, come to bear against the upper surface of the closure 14. When one continues to pivot transmission lever 32, the force exerted at the level of axis 56 is transmitted to hook 38, which causes a slight rotation of said hook, and more specifically of the tab of skirt 36 bounded by slits 70, towards the outside. This therefore simultaneously imparts a radial movement towards the outside and an axial movement towards the top of hook 38. During this rotation of the tab of skirt 36 including hook 38, part of closure 14 protrudes slightly in a radial direction in relation to the rest of skirt 36.

When one continues to pivot the transmission lever 32, bottle 12 is uncapped. Bottle-opener 10 is then withdrawn from bottle 12, the closure 14 remaining captive inside it, via hooks 38, 40 and 42.

So when using bottle-opener 10, transmission lever 32 moves from a rest position to a working position in which point 63 of the working portion 54 presses against the upper surface of closure 14, and in which hook 38 exerts a force on the lower surface of closure 14. Hooks 40 and 42 make it possible to ensure that hood 30 is maintained in position on bottle 12, by means of surfaces 40b, 42b whose shape matches that of the upper surface 44 of the finish 18a of bottle 12.

The layout of hook 38 and transmission lever 32 in the same axial plane P makes it possible to remove closure 14 successfully: the force exerted by the user on transmission lever 32 once the working portion 54 bears against closure 14, is transmitted directly to hook 38.

In addition, the applicant determined that the lack of a hook radially opposite hook 38 makes it possible to facilitate uncapping. The applicant also determined that the layout of hooks 40 and 42, circumferentially offset on either side of the position diametrically opposite hook 38, by about 40° to 50° and preferably by 45°, makes it possible to hold hood 30 properly on closure 14.

The applicant further noted that to obtain proper uncapping during movement of hook 38 when acted upon by transmission lever 32, the circumferential dimension of said hook 38 advantageously lies between 10 and 15% of the circumferential dimension of skirt 36. The circumferential dimension of hooks 40, 42 can to advantage be equal to half that of hook 38. The angular dimension of hook 38 can, for example, be about 45°.

In an alternative embodiment it can easily be seen that it is nevertheless possible, without moving outside the framework of the invention, to envisage a different number of hooks or a continuous or segmented radial rib. However, as stated above, the use of three hooks makes it possible to obtain particularly effective uncapping and stable positioning of bottle-opener 10 on bottle 12.

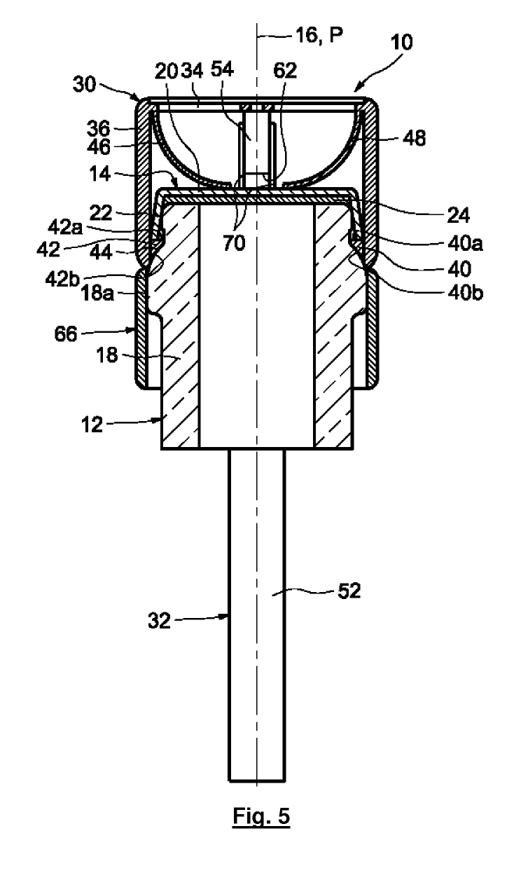

The embodiment illustrated in FIG. 5, in which identical parts bear the same references, differs in that bottle-opener 10 further comprises an overcap 66, generally ring-shaped, which extends a bottom end of skirt 36 axially downwards. Overcap 66 comes to bear against the finish 18a and extends axially along bottle 12 in the vicinity of the finish. To make it easier to be fitted around bottle 12, overcap 66 can to advantage be split.

Overcap 66 can be used to contribute to the package design of bottle 12, or present easily visible information about the liquid contained in bottle 12. To this end, the axial dimension of overcap 66 can to advantage lie between 50 and 300% of that of hood 30. However, it is also possible to envisage an overcap 66 that covers the bottle down to its base.

In this embodiment, overcap 66 is formed using the same procedure and material as skirt 36 in order to obtain a single-piece hood 30. It can easily be imagined that it is also possible to make two distinct parts and to make provision for adding overcap 66 onto hood 30.

The invention makes it possible to have a bottle-opener which is particularly simple and effective to use. In addition, the existence of at least one hook forming an axial means of holding the hood onto the closure makes it possible to fit the bottle-opener onto a bottle before it is put on sale. This gives a bottle provided with a closure assembly made up of the closure and the bottle-opener which, once bought by the consumer, can be opened without any external accessory.

It is easy to imagine that such a closure assembly could be provided for bottles designed to allow the conditioning of various types of liquids, such as water, wine, fruit juices, alcoholic beverages, or sparkling drinks of the soda or Champagne type. Moreover, in the case of sparkling drinks of the Champagne type, a satisfactory degree of safety is obtained when opening the bottle, in that the stopper is prevented from being blown off.

What is claimed is:

1. Bottle-opener for the closure of a bottle neck, including:
a hood equipped with a first hook having a contact surface with a lower surface of the closure, and
a transmission lever hinged on the hood and provided with a grip section and with a working portion ready to bear against an upper surface of the closure.

2. A bottle-opener, according to claim 1, wherein the first hook is aligned radially with the transmission lever.

3. A bottle-opener according to claim 1, wherein the hood further includes two other hooks circumferentially offset on either side of the position diametrically opposite the first hook.

4. A bottle-opener according to claim 1, wherein the hood includes a ring-shaped skirt, hooks being formed at one axial end of said skirt and extending radially inwards.

5. A bottle-opener according to claim 1, wherein the hood includes a radial portion equipped with at least one elastic component suitable for coming to bear against the upper surface of the closure.

6. A bottle-opener according to claim 1, wherein the transmission lever includes a recess matching the finish of the bottle.

7. A bottle-opener according to claim 1, further including an overcap as part of the package design of the bottle.

8. A bottle-opener according to claim 1, made with at least one synthetic material.

9. A closure assembly comprising a closure and a bottle-opener to be fitted to a bottle neck, and a bottle-opener provided with a hood comprising at least one means of holding said hood axially onto the closure and a transmission lever hinged on the hood and provided with a gripping portion and a working portion suitable for coming to bear against an upper surface of the closure.

10. A bottle containing a beverage, in particular an effervescent liquid, provided with a closure assembly according to claim 9.
